(19) United States
(12) Patent Application Publication
(10) Pub. No.: US 2007/0210600 A1
(43) Pub. Date: Sep. 13, 2007

(54) Keyless entry pickup truck toolbox

(76) Inventor: John S. Young, Raleigh, NC (US)

Correspondence Address: BLACK-E, LLC, 6908 WILDERNESS ROAD, RALEIGH, NC, 27613, US

(21) Appl. No.: 11/418,022

(22) Filed: May 4, 2006

Related U.S. Application Data
(60) Provisional application No. 60/780,199, filed on Mar. 9, 2006.

(51) Int. Cl. B60R 9/00

(52) U.S. Cl. 296/37.6

(57) ABSTRACT

A lockable toolbox having a main body and at least one lid. The toolbox has at least one latch attached to the main body, movable between a latched position, wherein the latch engages the lid to the main body so as to prevent the lid from opening, and an unlatched position, wherein the latch is disengaged from the lid so as to allow the lid to be opened. The toolbox has at least one lock, movable between an engaged (locked) position and a disengaged (unlocked) position, wherein the engaged position secures the toolbox such that the lid may not be opened merely by operation of the latch. The toolbox has at least one electro-mechanical actuator mechanically connected to the lock and electrically connected to a keyless entry system.

### CLAIM OF PRIORITY

This application claims priority to U.S. Provisional Application Ser. No. 60/780,199, filed Mar. 9, 2006, the disclosure of which is incorporated herein by reference.

### FIELD OF INVENTION

The invention relates to a self-contained toolbox, typical of those designed for use in the bed of pickup trucks. More particularly, the invention relates to an improved manner of securing such a toolbox.

### BACKGROUND

Self-contained toolboxes are often used to provide supplemental storage space within the bed of a pick-up truck. The toolboxes are enclosures secured at least partially within the bed of the truck, typically adjacent the front wall of the bed nearest the cab. The enclosures are typically provided with one or more hinged or slidable opening that allows access to the inside of the toolbox. The openings typically latch in a closed position and may or may not be lockable.

The toolboxes are often used to hold equipment, tools, and instruments. For example, a home-builder might store many of his or her more expensive tools in the toolbox rather than leaving them open within the bed of the truck. The toolbox user expects the toolbox to provide security for theft prevention and to protect the contents of the toolbox from the environment.

Users of the toolbox also expect the toolbox to be readily accessible. Complicated closures are undesirable. For instance, the user may have their hands full with equipment and may be unable to operate a complicated locking mechanism. Further, the user may be in a hurry and may find it undesirable to endure a lengthy opening process. Keyed latches are sufficient for security but may be undesirable because they require the user to maintain control of the key to the toolbox.

It has been suggested that the lock of a pickup truck toolbox could be electrically operated from within the cab of a pickup truck (U.S. Pat. No. 5,123,691). However, that would require entering the cab of the truck before unlocking the toolbox.

It has also been suggested that the latch of a toolbox could be released with a remotely operated solenoid (U.S. Pat. No. 5,727,835). However, it may be desirable in some circumstances to unlock and lock the toolbox without having the lid of the toolbox spring open each time.

It is desirable to provide an improved toolbox for use in the bed of a pick-up truck. Further, it is desirable to provide a toolbox capable of securing the contents of the box and providing the user with a quick and convenient method of securing and unsecuring the toolbox.

### SUMMARY

The invention is a lockable toolbox mountable within the bed of a motor vehicle, such as a pickup truck. The toolbox has a main body and at least one lid. The toolbox has at least one latch attached to the main body, movable between a latched position, wherein the latch engages the lid to the main body so as to prevent the lid from opening, and an unlatched position, wherein the latch is disengaged from the lid so as to allow the lid to be opened. The toolbox has at least one lock, movable between an engaged (locked) position and a disengaged (unlocked) position, wherein the engaged position secures the toolbox such that the lid may not be opened merely by operation of the latch. Finally, the toolbox has at least one electro-mechanical actuator mechanically connected to the lock and electrically connected to a keyless entry system.

In use, selective operation of the actuator alternately positions the lock between the engaged and disengaged position. When the lock is engaged, the lid is prevented from opening even with attempted operation of the latch. When the lock is disengaged, the lid is free to open upon operation of the latch. Thus, the toolbox may be conveniently secured and unsecured with a keyless entry system.

According to one embodiment of the invention, the actuator is electrically connectable to the keyless-entry system of a motor vehicle, i.e. a keyless-entry system connected to the door locks of the vehicle, such that the toolbox may be locked or unlocked with the vehicle's keyless-entry system.

According to another embodiment, the toolbox comprises a self-contained keyless-entry system (i.e. separate from any keyless-entry system connected to the vehicles doors) electrically connected to the actuator.

According to another embodiment, the at least one lock of the toolbox is keyed to allow operation of the lock independently of the electro-mechanical member.

According to another embodiment, the lock is not externally accessible.

According to another embodiment, the toolbox comprises a second actuator connected to a latch of the toolbox such that operation of the second actuator causes the lid of the toolbox to be released from the latch.

According to another embodiment, the toolbox is installed within the bed of a pickup truck, and the invention comprises a pickup truck having a cab and a bed, wherein the toolbox, as described herein, is installed within the bad of the pickup truck.

The ability to actuate the lock on the toolbox with a keyless-entry system provides many advantages over toolboxes of the past. For instance, when the toolbox is installed within the bed of a pickup truck and connected to the trucks keyless-entry system, the operator of the pickup truck need not spend the time or effort to unlock or lock the toolbox separately from unlocking or locking the truck itself. The toolbox will be unlocked whenever the doors of the truck are unlocked and locked whenever the doors of the truck are locked. Further, the operator of the pickup truck need not carry and keep track of the key to the toolbox for locking and unlocking the toolbox.

With use of the keyless-entry system, the operator does not have to enter the cab of the truck to electrically operate the actuator as with previous electrically actuated toolboxes. This provides numerous advantages over the previous toolboxes, including convenience and time saved in unnecessarily opening the cab door, and the peace of mind of knowing that the toolbox is secured whenever the truck cab is locked with its keyless-entry system.

### DETAILED DESCRIPTION OF THE DRAWINGS

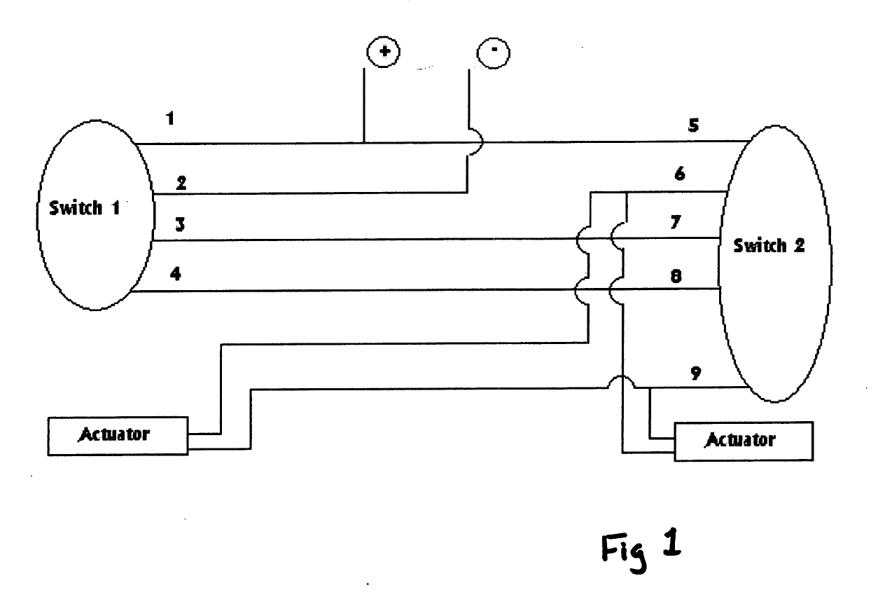

FIG. 1 is a schematic showing an exemplary power door lock system;

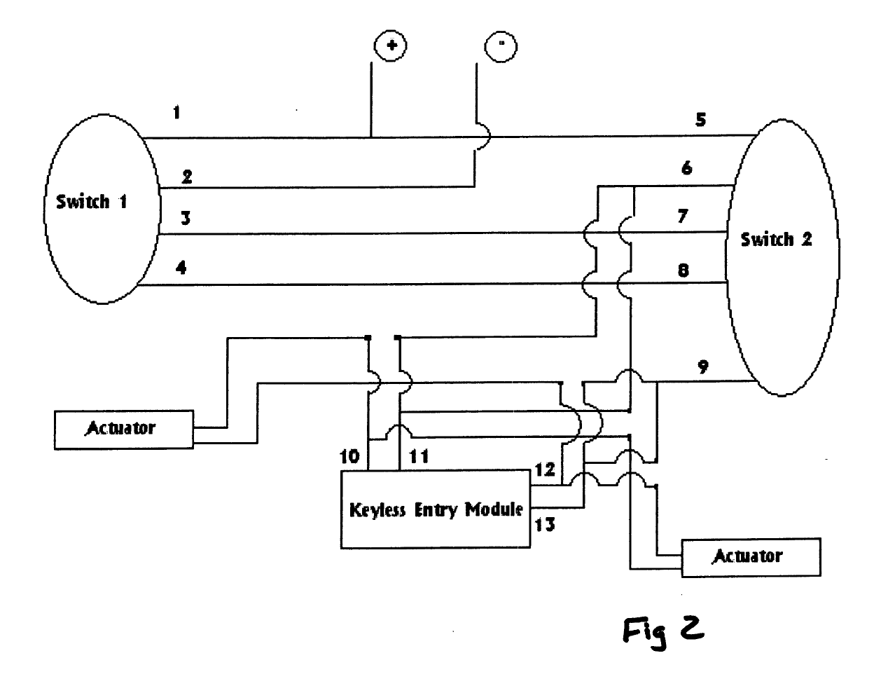

FIG. 2 is a schematic showing an exemplary power door lock system connected to a keyless entry module;

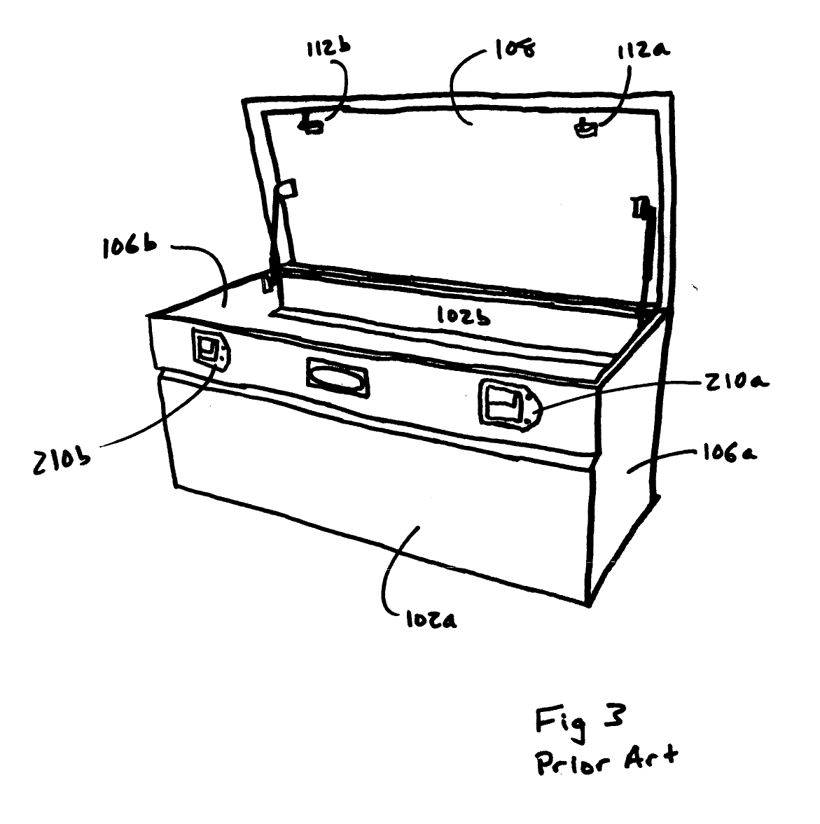

FIG. 3 shows an exemplary toolbox of the prior art;

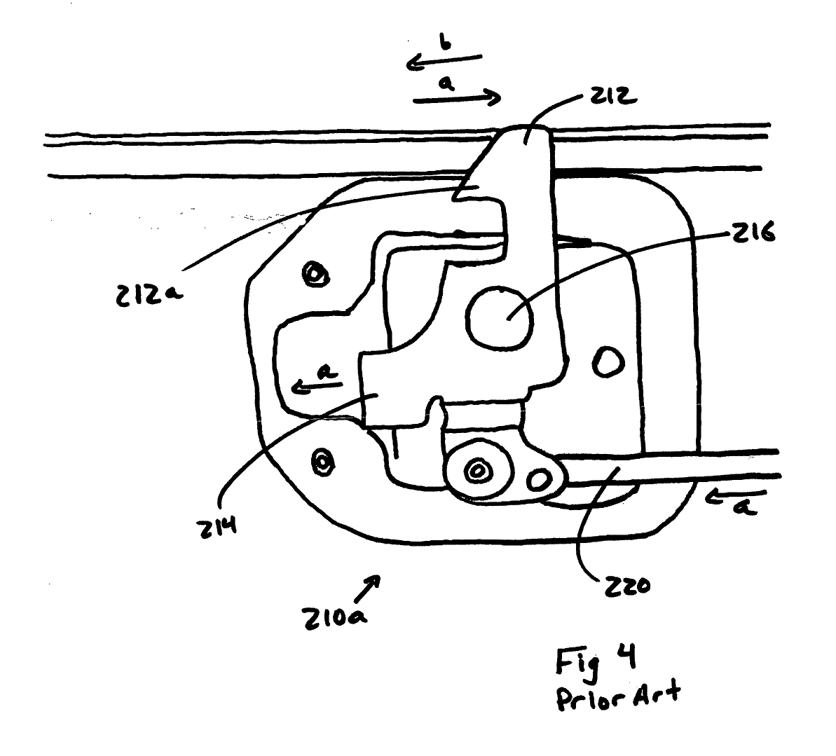

FIG. 4 shows a close up view of a latch of the prior art toolbox of FIG. 3;

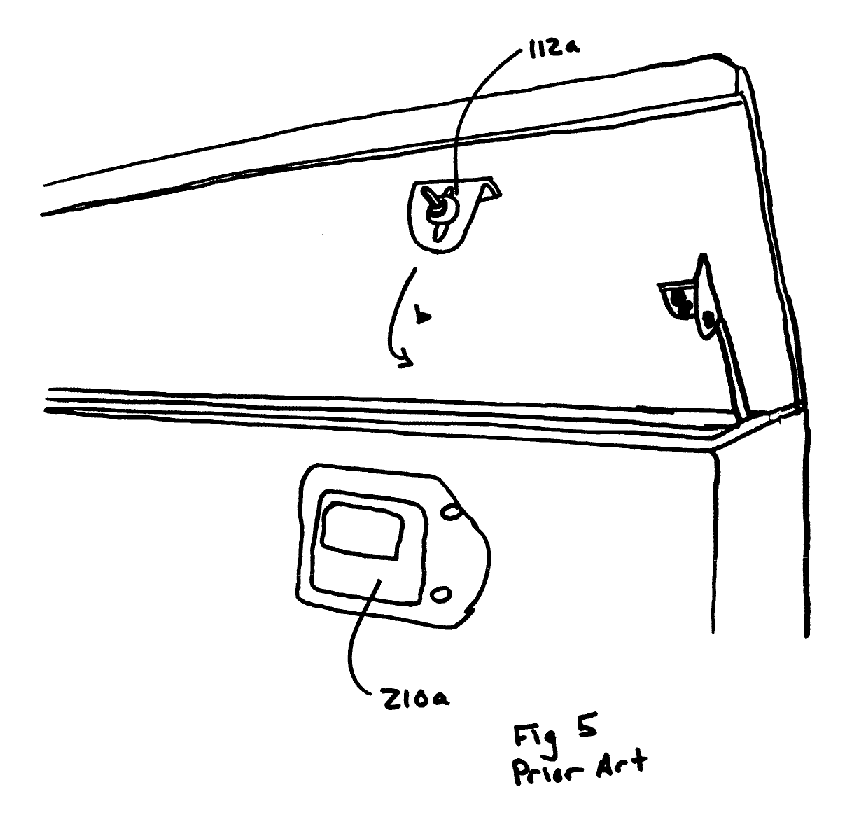

FIG. 5 shows another view of the latch of the prior art toolbox of FIG. 3;

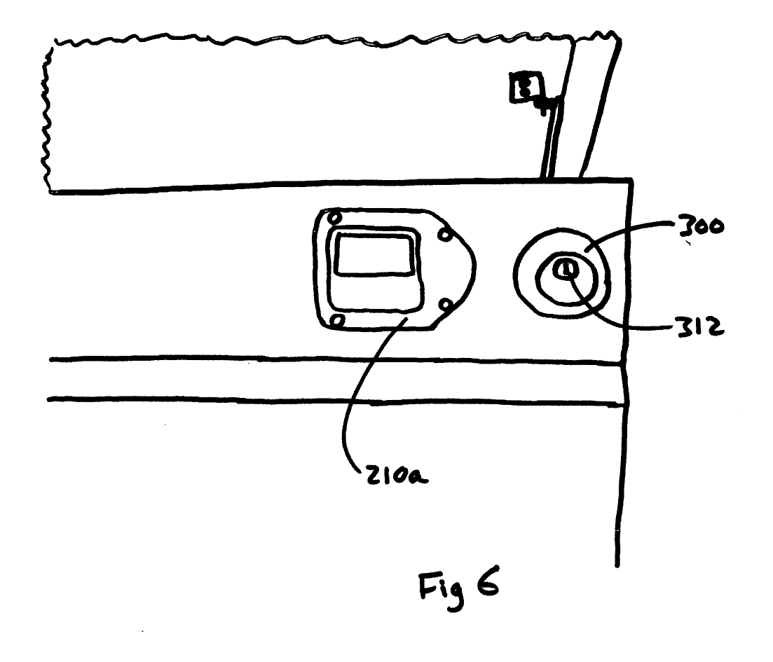

FIG. 6 shows a lock installed within a toolbox according to an embodiment of the invention;

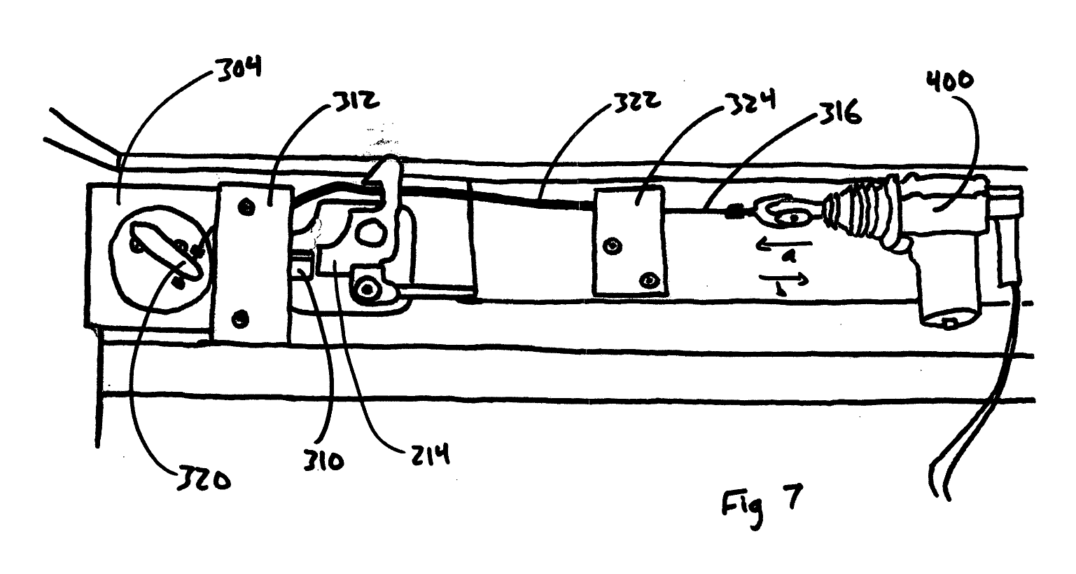

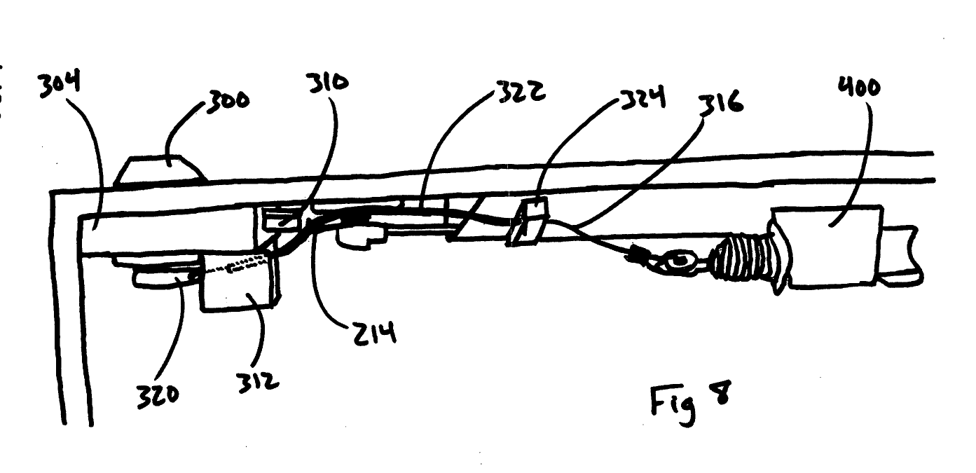

FIGS. 7 and 8 show an exemplary configuration of a lock and actuator configuration of the invented toolbox according to another embodiment of the invention;

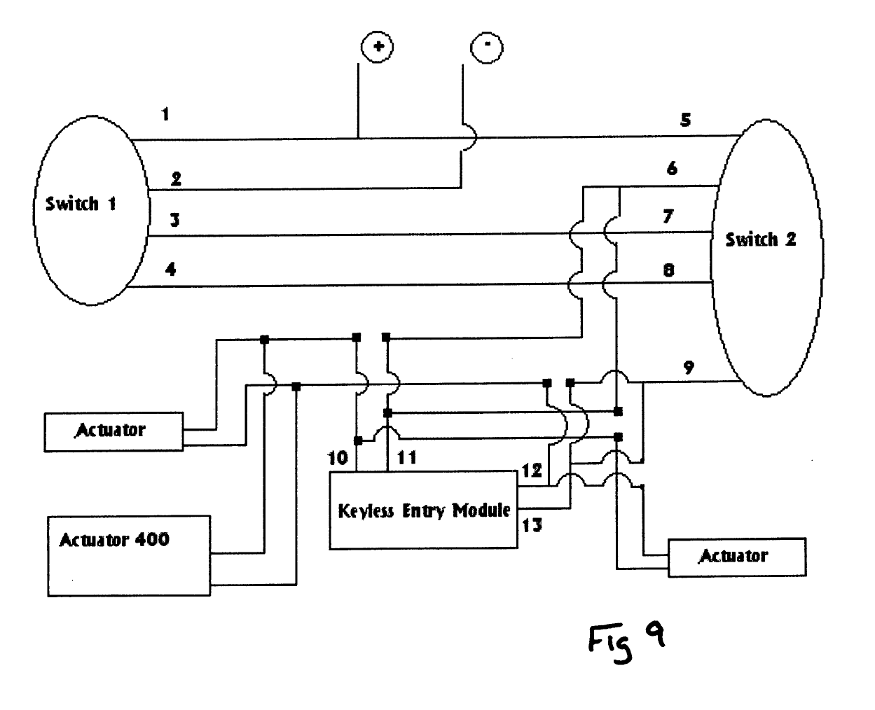

FIG. 9 is a schematic showing an actuator connected to the door lock system of FIG. 2 according to another embodiment of the invention; and

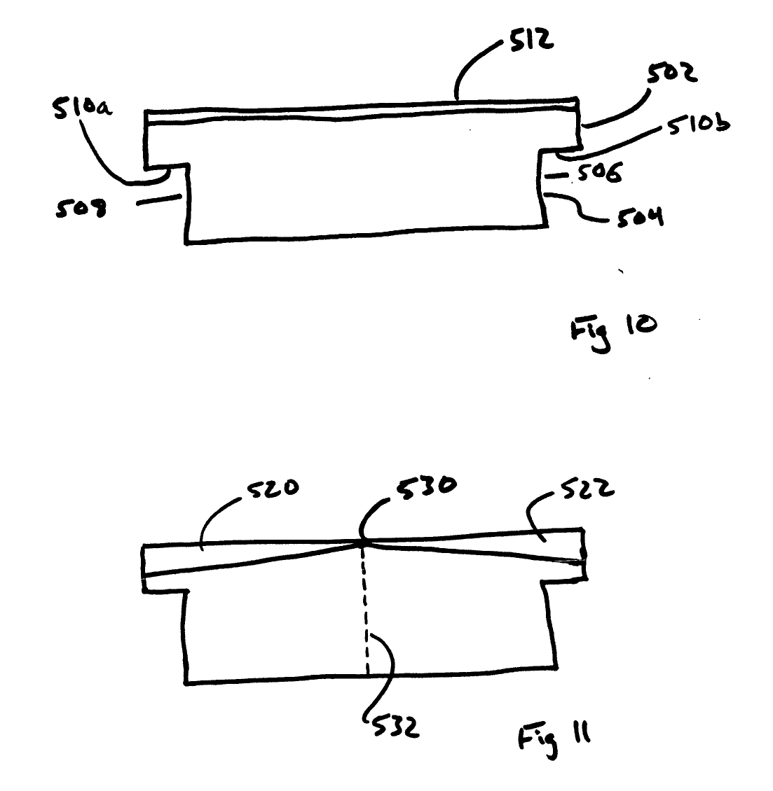

FIGS. 10 and 11 show particular types of toolboxes encompassed by the invention.

### DETAILED DESCRIPTION

The “toolbox” is a solid-walled container having a size and shape so as to be at least partially disposable within and affixable to the bed of a pick-up truck.

The toolbox may be provided in various shapes and configurations as known to those in the art. Examples of commercially available toolboxes include but are not limited to the Platinum Series of toolboxes available from Dee Zee, Inc., Des Moines, Iowa, and various truck toolboxes available from Leonard Buildings and Truck Accessories, Raleigh, N.C.

According to a first particular form of the toolbox, the toolbox may be a lidded chest such as described more particularly below as the Exemplary Toolbox. According to a second particular form of the toolbox, as shown in FIG. 10, the toolbox has an upper portion 502 and a lower portion 504, said toolbox having a pair of lateral sides 506 and 508, said upper portion 502 having a width greater than a distance between said first 506 and second walls 508 and said lower portion 504 having a width less than a distance between said first 506 and second side walls 508 such that a flange 510a,b is defined in each of said lateral sides at a juncture of said upper and lower portions, and a lid 512 is mounted on the toolbox for accessing the interior of the toolbox. According to a third particular form of the toolbox, as shown in FIG. 11, the toolbox may include a pair of lids 520, 522. In this form, each of the lids may be mounted for rotation near the middle portion 530 of the upper portion of the toolbox. The toolbox may be divided into two equal portions by a wall 532 positioned within the middle of the toolbox and extending parallel to the length of the vehicle.

The toolbox has at least one latch for latching the lid of the toolbox closed. The latch is movable between a latched position, wherein the latch engages the lid so as to prevent the lid from opening, and an unlatched position, wherein the latch is unengaged from the lid so as to allow the lid to be opened. The latch is typically operated from the outside of the toolbox by such means as a handle or push-button.

The toolbox has at least one lock. When engaged, the lock secures the toolbox such that the toolbox may not be opened merely by operation of the latch. The lock is advantageously accessible from the outside of the toolbox in the form of a keyed slot. Alternatively, the lock is not externally accessible. According to one embodiment, the lock secures the toolbox by blocking the latch, i.e. blocking movement of the latch such that the latch cannot be disengaged when the lock is engaged. According to another embodiment, the lock secures the toolbox be separating the latch from the handle or push-button that operates the latch such that the handle/push-button does not disengage the latch when the lock is engaged. According to another embodiment, the lock secures the toolbox by mechanically linking the lid with the main body of the toolbox such that the lid cannot be opened until the lock is disengaged.

The toolbox has at least one actuator affixed to the toolbox. The actuator is an electro-mechanical device wherein a portion of the actuator moves in response to an electrical input. The actuator operates in a 2-way manner, i.e. unlock and lock, such that the actuator is positioned in a first position, called herein the “locked” position, in response to a lock signal and is positioned in a second position, called herein the “unlocked” position, in response to an unlock signal. By way of example, the actuator 400 shown in FIG. 7 extends in direction (a) in the unlocked position, and retracts in direction (b) in the locked position. The actuator is mechanically connected to the lock such that operation of the actuator causes movement of the lock to/from a corresponding locked or unlocked, i.e. engaged or disengaged, position.

The actuator is electrically connected to a keyless entry system, such as those typically found in commercially available motor vehicles. The keyless entry system is activated by a remote transmitter, such as a key fob. Upon operation of the key fob or other signaling device by the user, the keyless entry system produces electrical pulses corresponding to the desired operation, i.e. unlocking or locking. According to one embodiment, the keyless entry system is housed within the motor vehicle, typically in the engine compartment, and is connected to power door locks of the vehicle. In another embodiment, the keyless entry system is housed within the toolbox, i.e. self-contained, and is not operatively connected to the door locks of the vehicle. The keyless entry system is advantageously powered by the main power system of the vehicle.

One of skill in the art will recognize that different types of keyless entry modules may be used with the invention. For instance, the module may be designed to operate upon receiving analog or digital signals, such as radio signals. The signals may be unencoded or encoded, such as a roaming code that varies by a preset algorithm.

For toolboxes with multiple locks, there is advantageously an actuator corresponding to each lock, or the actuator is mechanically linked to each of the locks such that operation of the actuator correspondingly operates the attached locks.

Many keyless entry systems have an operation corresponding to a “trunk open” signal. In a typical configuration in a motor vehicle, the keyless entry system has a one-way actuator attached to the trunk such that the trunk open signal results in the trunk being released. Similarly, according to an optional embodiment, the toolbox may be equipped with a one-way actuator mechanically attached to the latch of the toolbox such that the toolbox may be opened, if already unlocked, by activation of the one-way actuator.

One of skill in the art will recognize that one or more relays may be used in conjunction with the keyless entry system if desired to power the additional actuator or the toolbox.

Each aspect of the invention is further clarified with reference to the Examples presented below.

### EXAMPLES

Exemplary Power Lock Actuators

A commercially available power door lock kit (Ameripro Industries Inc., Dallas, Tex.) comprises two switches and two actuators designed to be installed, one each in the left and right doors, respectively, of an automobile or truck. Both actuators respond together by extending or retracting in response to operation of either of the switches. The system is configured as shown in FIG. 1. The actuators are extended by positioning of either switch into a first position, referred to herein as the (a) position. The actuators are retracted by positioning of either switch into a second position, referred to herein as the (b) position.

TABLE 1
Exemplary Power Lock Configuration

| Position | Switch 1 | Switch 2 | Actuators |
|---|---|---|---|
| (a) | 3 & 6 are + | 6 is + | Extended |
| (b) | 4 & 9 are + | 9 is + | Retracted |

Exemplary Keyless Entry Module

A commercially available keyless entry module (Model KE100 from Bulldog Security, Steubenville, Ohio) is connected to the Exemplary Power Lock Actuators as illustrated in FIG. 2, wherein contacts 10 and 11 are the lock-motor and lock-switch, and wherein contacts 12 and 13 are the unlock-switch and unlock-motor, respectively.

Exemplary Toolbox

Referring to FIG. 3, a commercially available 42″ chest box 100 (Model TBX-TBC42, Leonard Buildings and Truck Accessories, Raleigh, N.C.) marketed for use as a pickup truck toolbox, has a bottom (not shown), opposing front 102a and rear 102b walls, and opposing side walls 106a and 106b. The box 100 has a single lid 108 hingeably attached to the rear wall 102b. There are two latches 210a and 210b located in the front wall 102a of the box, and two pegs 112a and 112b attached to the lid 108. The latches 210a and 210b correspond to pegs 112a and 112b, respectively, such that the latches engage and secure the respective pegs upon closure of the lid, thereby securing the lid in a closed position until the latches are released.

Referring to FIG. 4, latch 210a is shown as viewed from within the box. A first member of the latch comprises a hook 212 portion and a stop 214 portion. When the lid of the box is closed, the peg 112a is maintained under the lip 212a of hook portion 212. The first member is attached to a handle on the outside of the box such that pulling on the handle causes the first member to rotate about pivot point 216 in direction a, thereby releasing peg 112a from under the lip 212a. The first member is spring biased so that it returns to its resting position (b) when the handle is released. When the first member rotates in direction (a), the stop 214 also moves in the direction indicated (a) and connecting rod 220 is pulled as indicated (a). The connecting rod 220 simply connects the respective first members of latches 210a and 210b so that pulling either external handle will operate both latches. Referring to FIG. 5, another view of the box is shown to demonstrate the movement of peg 112a relative to latch 210a.

Exemplary Lock and Actuator Configuration

Referring to FIGS. 6, 7, and 8, a commercially available deadbolt-style lock 300 (Model B360N, from Schlage) is installed in the front wall 102a of the box, between the latch 210a and the side wall 106a of the box, with the key hole 302 side of the deadbolt facing outward and the hand lever of the deadbolt facing the inside of the box.

To install the deadbolt, a first wooden block 304 is cutout with a circular cutout corresponding to the main body of the lock and a smaller cutout corresponding to the bolt of the lock just as one of skill in the art would cutout a residential door for installation of the lock. A hole the size of the lock main body cutout is made through the box through the front wall 102a of the box, and the lock is assembled through box wall 102a and the first wooden block 304, with the first wooden block 304 flush against the inside of wall 102a.

The lock is positioned such that when the bolt 310 of the lock is extended, the bolt 310 abuts stop 214 of the latch. Thus, when the bolt is extended it prevents rotation of the first member of the latch and opening of the box.

A second wooden block 312 is attached to the first wooden block as shown. A small gauge steel bicycle cable 316 is threaded through the block 312. A first end of the cable 316 is threaded through a hole drilled in the handle 320 of the deadbolt lock. A second end of the cable extends through a flexible housing 322 from the second block 312 to a third block 324, and then attached to the moving portion of an actuator 400. The actuator is fastened to a small metal flap extending from the inside of the box.

Connection of Keyless Entry Toolbox to Vehicle Keyless Entry System

Referring to FIG. 9, actuator 400 is electrically connected, in parallel, with a power lock actuator described above. This configuration represents the connection of the toolbox actuator 400 with the keyless entry system of a motor vehicle.

1. A keyless entry pickup truck toolbox, comprising
a main body and at least one lid,
at least one latch attached to the main body, movable between a latched position, wherein the latch engages the lid so as to prevent the lid from opening, and an unlatched position, wherein the latch is disengaged from the lid so as to allow the lid to be opened,
at least one lock, movable between an engaged position and a disengaged position, wherein the engaged position secures the lid to the main body such that the lid may not be opened merely by operation of the latch,
at least one actuator mechanically connected to the lock and electrically connected to a keyless entry system.

2. The toolbox of claim 1, wherein the keyless entry system is the keyless-entry system of a motor vehicle.

3. The toolbox of claim 1, wherein the keyless-entry system is self-contained.

4. The toolbox of claim 1, wherein the at least one lock of the toolbox is keyed to allow operation of the lock independently of the electro-mechanical member.

5. The toolbox of claim 1, wherein the lock is not externally accessible.

6. The toolbox of claim 1, comprising a second actuator connected to a latch of the toolbox such that operation of the second actuator causes the lid of the toolbox to be released from the latch.

7. The toolbox of claim 1, wherein the toolbox has an upper portion and a lower portion, said toolbox having a pair of lateral sides, said upper portion having a width greater than a distance between said first and second walls and said lower portion having a width less than a distance between said first and second side walls such that a flange is defined in each of said lateral sides at a juncture of said upper and lower portions, and a lid is mounted on the toolbox for accessing the interior of the toolbox.

8. The toolbox of claim 1, wherein the lock secures the toolbox by blocking movement of the latch such that the latch cannot be disengaged when the lock is engaged.

9. The toolbox of claim 1, wherein the lock secures the toolbox be separating the latch from the handle or push-button that operates the latch such that the handle/push-button cannot disengage the latch when the lock is engaged.

10. The toolbox of claim 1, wherein the lock secures the toolbox by mechanically linking the lid with the main body of the toolbox such that the lid cannot be opened until the lock is disengaged.

11. A pickup truck comprising
a passenger compartment,
a truck bed, and
a toolbox comprising
a main body and at least one lid,
at least one latch attached to the main body, movable between a latched position, wherein the latch engages the lid so as to prevent the lid from opening, and an unlatched position, wherein the latch is disengaged from the lid so as to allow the lid to be opened,
at least one lock, movable between an engaged position and a disengaged position, wherein the engaged position secures the lid to the main body such that the lid may not be opened merely by operation of the latch,
at least one actuator mechanically connected to the lock and electrically connected to a keyless entry system,
wherein the toolbox is disposed within the truck bed.

12. The pickup truck of claim 11, wherein the pickup truck is equipped with a keyless-entry system to which the actuator is electrically connected.
